(19) United States
(12) Patent Application Publication
(10) Pub. No.: US 2009/0204946 A1
(43) Pub. Date: Aug. 13, 2009

(54) INTELLIGENT SOFTWARE CODE UPDATER

(75) Inventors: Shachar Fienblit, Ein Ayala (IL); Itzhack Goldberg, Hadera (IL); Aviad Zlotnick, Milzeph Netofa (IL)

Correspondence Address: INTERNATIONAL BUSINESS MACHINES CORPORATION, 650 Harry Road, L2PA/J2C, INTELLECTUAL PROPERTY LAW, SAN JOSE, CA, 95120-6099, US

(73) Assignee: International Business Machines Corporation, Armonk, NY (US)

(21) Appl. No.: 12/030,085

(22) Filed: Feb. 12, 2008

(51) Int. Cl. G06F 9/44

(52) U.S. Cl. 717/124

(57) ABSTRACT

A method for modifying executable logic code stored on a computing system is provided. The method comprises assessing a risk level associated with modifying a first code block and assessing an urgency level associated with modifying the first code block and then evaluating whether the first code block should be modified.

### COPYRIGHT & TRADEMARK NOTICES

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

### FIELD OF INVENTION

The present invention relates generally to software and, more particularly, to a system and method for selectively updating software code.

### BACKGROUND

Software code may need to be updated from time to time to fix a pre-existing flaw or defect in the software code or perhaps to improve or to add a new feature to the preexisting software functionality. A newly added feature may be of more or less importance to different users, but severity of the flaws or defects in the code and the frequency with which such flaws occur render some software updates more urgent than others.

Currently, software updates are proposed as a take it or leave it option. That is, a user or a system administrator generally installs an update with no or little knowledge of the effects of the update. In case of an individual user especially, the user often does not know whether the update will result in a significant improvement or if it could introduce a potential hazard to the system.

For example, a software update may result in creation of a new bug or unexpected system behavior (e.g., a system crash or slower operation speeds). Therefore, sometimes it is hard to determine whether a software update should be authorized. The lack of information about the nature of an update and the potential risk of detrimental effects on the target system leads some users to avoid software updates altogether.

Thus, software update methods and systems are needed that can overcome the aforementioned shortcomings.

### SUMMARY

The present disclosure is directed to systems, methods and corresponding products that facilitate selective and intelligent update of software code, such that portions of the code are updated in a manner to achieve a desired balance between urgency and risk associated with updating different section of the code.

A method for modifying executable logic code stored on a computing system is provided. The method comprises assessing a risk level associated with modifying the first code block; assessing an urgency level associated with modifying the first code block; and evaluating whether the first code block should be modified. The method may further include, wherein the urgency and the risk levels are assessed based on execution history of the first code block and modification data associated with the first code block.

The data associated with execution history of the first code block may comprise at least one of frequency of execution of the first code block, number of times the first code block is executed, number of times execution of the first code block has resulted in an error, whether the first code block was executed at all, and whether execution of the first code block supports execution of a second code block.

Modification data may comprise status information identifying whether the code is being modified for the purpose of at least fixing a problem encountered in executing that block, fixing a problem encountered in executing another block of code, or modified for improving functionality of that block.

One or more of the above-disclosed embodiments in addition to certain alternatives are provided in further detail below with reference to the attached figures. The invention is not, however, limited to any particular embodiment disclosed.

### BRIEF DESCRIPTION OF THE DRAWINGS

Embodiments of the present invention are understood by referring to the figures in the attached drawings, as provided below.

FIG. 1 illustrates an exemplary computing system environment, in accordance with one or more embodiments.

FIG. 2 is a flow diagram of a method for modifying executable logic code, in accordance with one embodiment.

FIGS. 3A and 3B are flow diagrams of exemplary methods for determining urgency and risk associated with modifying executable logic code on a computing system, in accordance with one or more embodiments.

FIGS. 4 and 5 are block diagrams of hardware and software environments in which a system of the present invention may operate, in accordance with one or more embodiments.

### DETAILED DESCRIPTION OF EXEMPLARY EMBODIMENTS

Numerous specific details are set forth to provide a thorough description of various embodiments of the invention. Certain embodiments of the invention may be practiced without these specific details or with some variations in detail. In some instances, certain features are described in less detail so as not to obscure other aspects of the invention. The level of detail associated with each of the elements or features should not be construed to qualify the novelty or importance of one feature over the others.

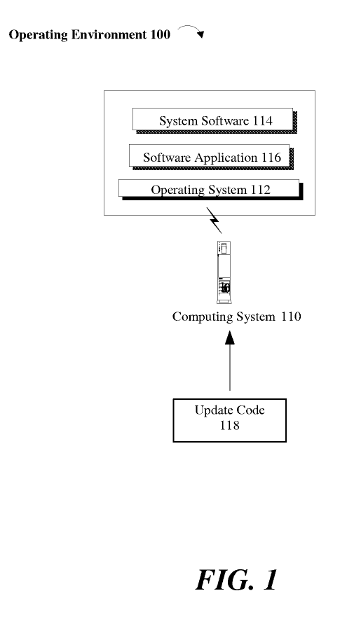

Referring to FIG. 1, an exemplary operating environment 100 for updating software code is illustrated. In accordance with one aspect of the invention, software application 1 16 is executed on top of operating system 112 running on a computing system 110. Computing system 110 may be a personal computer or another computing system (e.g. a set-top box, a personal digital assistant (PDA), a cellular communication device), a storage controller, an enterprise server, an appliance controller, or other system capable of data storage or data communication.

Software application 116 may comprise executable logic code blocks that may be modified by update code 118. Depending on implementation, code modification or update may be initiated, in one embodiment, by a user of computing system 110, an administrator, a software provider or an automated remote update service (not shown).

In one embodiment, system software 114 is executed on computing system 1 10 and is configured to monitor and collect information about usage pattern and execution history of logic code (including without limitation, software application 116) executed on computing system 110 (S2010). In some embodiments, instead or in conjunction with system software 114, operating system 112 or another locally or remotely running software application (not shown) may perform one or more related tasks attributed to system software 114 as provided in the following. Thus, it is noteworthy that system software 114 is provided as an exemplary software used for the purpose of monitoring and collecting execution activity on computing system 110 and the scope of the invention should not be construed as limited to system software 114.

The collected information may be stored, for example, in form of a log that comprises the execution history and usage pattern of logic code blocks in software application 116. The execution history may comprise data collected over a specific time frame. The collected execution history data may, for example, include at least one or more of the following about software application 116: (1) the frequency of execution of one or more logic code blocks, (2) the number of times a logic code block is executed, (3) the number of times an error resulted due to the execution of a logic code block, (4) whether a first logic code block in software application 116 supports the execution of a second logic code block in software application 116 or other application running on computing system 110, and (5) whether the first code block was executed at all.

The level of urgency associated with upgrading a logic code block may be determined in accordance with the collected history data and modification data that provides status information identifying whether the code was modified for the purpose of at least fixing a problem encountered in executing that block, fixing a problem encountered in executing another block of code, or modified for improving functionality of that block.

In one embodiment the urgency level is assessed as high, when the frequency of execution of the first code block is greater than a first threshold and the modification data shows that the block was modified because of an error in it. In certain embodiments the risk level is assessed as high when the frequency of execution of the first code block is greater than a second threshold, and wherein modification of the first code block is not for fixing a problem directly associated with the execution of the first code block. In other embodiments, the risk level is assessed as low, when the frequency of execution of the first code block is less than a third threshold, and wherein modification of the first code block is to fix a problem directly associated with the execution of the first code block.

The collected data may be stored in a database, a text file or any data structure suitable for recording and tracking the execution history of logic code blocks in software application 116. The execution history may also include a timestamp indicating when a code block was executed, the running total of executions for each code block, any execution interdependencies between the various code blocks, and the time since a code block was last executed. The collected data and history may further provide information about the type and number of errors that might have occurred during the execution of a code block.

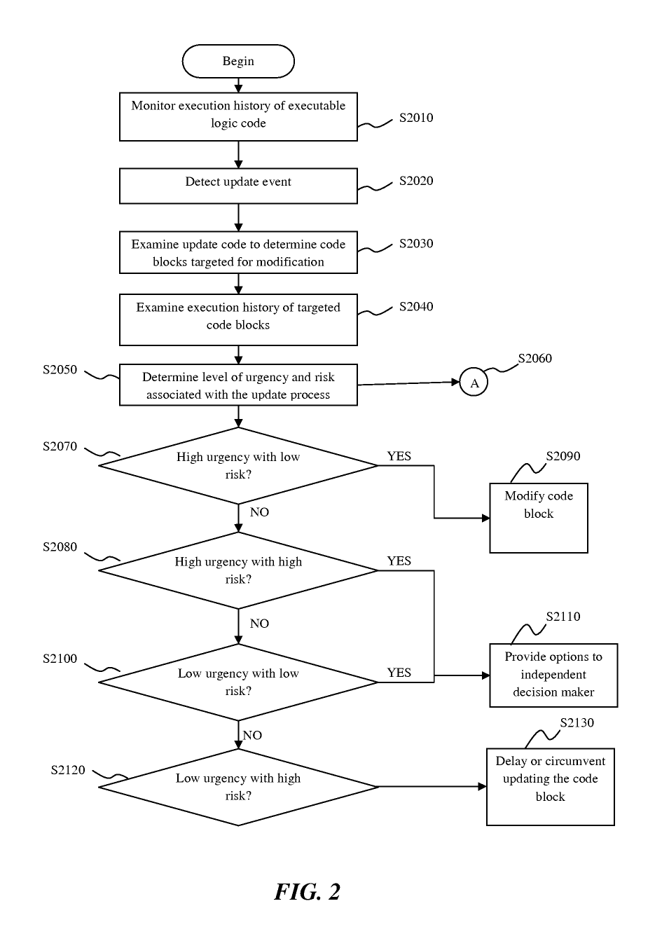

Referring to FIG. 2, system software 114 is configured to detect an update event (S2020) in response to, for example, an update code 118 being downloaded to computing system 110. The update code 118 may be downloaded by a user of computing system 110, by a system administrator or a software provider, either automatically or by way of a software update/maintenance service. Without limitation, the update may be for the purpose of correcting bugs or errors in software application 116, to improve system efficiency, or to implement additional functionality or security features in software application 116.

In one embodiment, system software 114 examines update code 118 to determine which code blocks in software application 116 are targeted for modification by update code 118 (S2030). Update code 118 may comprise information about the nature and the reason for modification of target code blocks in software application 116. System software 114 may examine execution history of targeted code blocks (S2040). This examination may lead to identification of the usage characteristics and other performance data associated with the code blocks that are to be modified.

As provided in more detail below, system software 114 may also determine whether the targeted code blocks support features that are frequently used by a certain user or whether said code blocks are critical or important to the successful execution of other code blocks that support important features of software application 116. Based on the examination of update code 118 and execution history of the targeted code blocks, system software 114 may determine level of urgency and risk associated with the update process (S2050).

Depending on implementation, the urgency level may depend on the extent to which the update code 118 fixes code blocks in software application 116 that contain errors, and how critical the targeted code blocks are to the user, or to the functionality of software application 116. The level of critical aspects may be depend on, for example, how often certain features are utilized and whether updating the logic code may affect the proper operation of certain important features.

Accordingly, if the code blocks targeted for modification are executed frequently or recently, and if such code blocks are needed to ensure efficient and robust execution of software application 116, then system software 114 may determine that updating one or more targeted code block is critical or urgent. On the other hand, where certain targeted code blocks are rarely executed or are not important to the proper and efficient operation of software application 116, then there is a low level of importance or urgency associated with updating such code blocks.

In certain embodiments, a factor in assessing the urgency of an update is whether the update corrects a problem in a block that is to be modified as a result of the update. If not (e.g., if the update is for enhancing function or improving performance), the update procedure is not considered as urgent. The following chart provides exemplary situations which can be used to determine the urgency level associated with an update procedure for a code section, in accordance with one or more embodiments.

| | Update for the code | Update for the code |
|---|---|---|
| | block is associated | block is not associated |
| | with fixing | with fixing a bug in |
| | a bug in the block | the block |
| Block to be updated | High Importance, low | Low importance, high |
| was in use | risk | risk |
| (e.g., previously | There is an error in the | The code works |
| executed or | block of code that is in | correctly, and is in use. |
| frequently | use. It is important to | Updating the code is |
| executed) | fix it by way of the | therefore risky, since |
| | update, and most | the code has been |
| | probably there is more | running successfully |
| | risk in leaving the code | and is not defective. |
| | as is than in applying | |
| | the change. | |
| Block to be updated | Medium importance, | Low importance, |
| was not in use | low risk | medium risk |
| (e.g., previously not | There is an error in a | There is a modification |
| executed or not | block of code that has | in code that works |
| frequently executed) | not been in use. There | correctly, and has not |
| | is some importance in | been in use. This |
| | fixing it, because it may | modification is almost |
| | be used eventually, and | risk, but the risk is not |
| | the risk is low both | high because the code |
| | because most probably | is not used frequently. |
| | there is more risk in | |
| | leaving the code as is | |
| | than in applying the | |
| | change, and because the | |
| | code is not used | |
| | frequently. | |

As noted above, in some embodiments, the level of urgency associated with a code block may be determined based on the frequency with which a code block is executed or the number of times that code block has been executed during a predetermined time period. For example, a code block that is executed more than five times per day, during a 30-day period, may be deemed as having a high level of importance or urgency associated with it, while a code block that is executed only once every other week, during a 30 day period, may be deemed as having a low level of importance or urgency for the purpose of being updated.

In certain embodiments, a high level of urgency or importance may be associated with a code block that is determined to have a bug, or a code block that supports a feature important to a user, regardless of how frequently that code block is executed. Furthermore, a first code block having none of the above-discussed characteristics may be deemed as having a high level of importance or urgency, if that first code block supports the execution of a second code block, where the second code block is deemed important or determined as associated with a high urgency or importance level.

Determination of the risk level may depend on the probability or the extent to which the targeted code block can introduce a bug or flaw into system operations, if updated. The risk level may be determined to be high, for example, if the targeted code block is not the direct cause of any execution errors or undesirable functional effects, as reflected by the execution history of software application 116. Accordingly, the risk level may be determined based on how well behaved a targeted code block has been in the past. For example, a high-risk level may be associated with code blocks that are executed frequently and do not have a history of causing errors when executed.

As noted earlier, the data associated with the modification of a block of code (i.e., modification data) may comprise status information identifying whether the code was modified for the purpose of at least fixing a problem encountered in executing that block, fixing a problem encountered in executing another block of code, or modified for improving functionality of that block. Once the modification data (e.g., the reason for updating the code) and the usage history of the block to be updated (e.g., frequency of use and therefore the level of importance of the code block to a user) are known, then an intelligent decision can be made on whether or not to authorize the update process for a certain block of code.

In one embodiment, information from multiple blocks in a code upgrade is combined prior to authorizing an update. If any block is determined to be high risk, the whole upgrade is deemed to be high risk, else it is deemed as low risk. If upgrading any block is deemed to be urgent, however, the whole upgrade is deemed as urgent, else the upgrade won't be considered urgent.

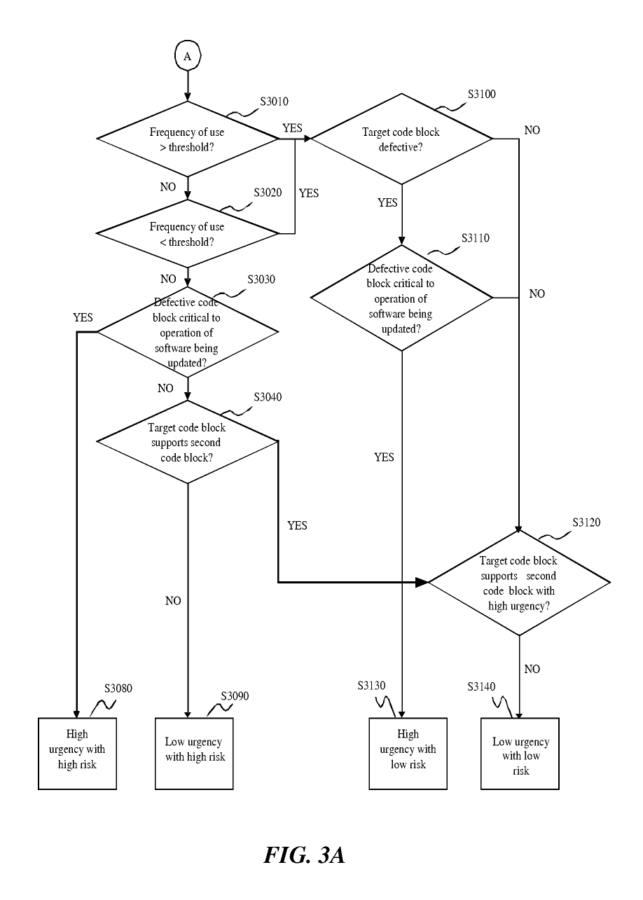

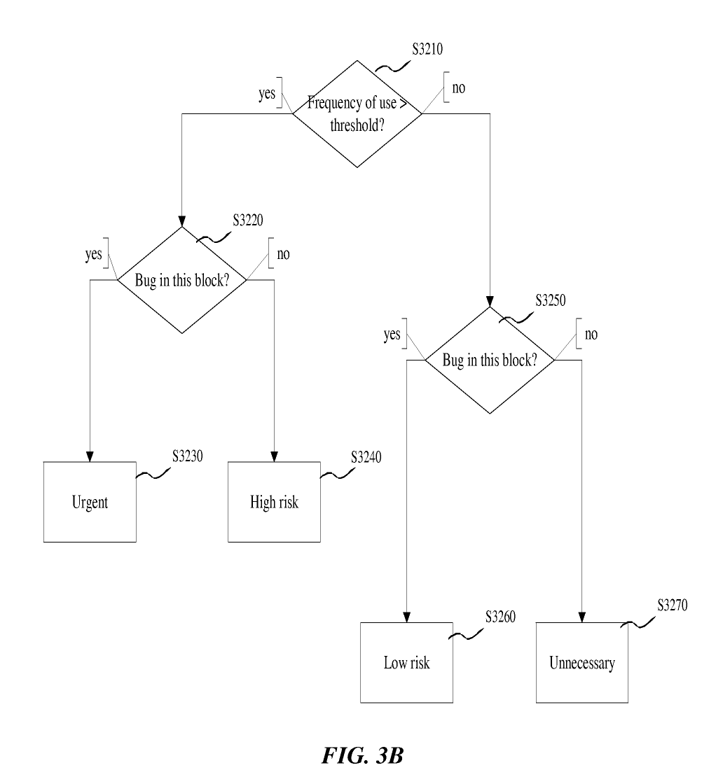

Referring to FIG. 3A, different exemplary conditions are illustrated on how the urgency and risk levels may be determined for a target code block, in accordance with one embodiment. As discussed, if the target code block is determined to be critical to operation of software application 116 being updated, then the urgency and risk level for updating such code block may be high (S3010-S3080); if the target code block is determined not to be critical to operation of software application 116, then the urgency level may be low and risk level for updating such code block may be high (S3010-S3090).

If the target code block is executed frequently and is considered to be defective, or supports a second code block that is considered to have a high urgency level, then the urgency level for such code block may be high and the risk level may be low (S3010-S3130); if no history of defects is associated with a target code block, then both the urgency and risk level for updating such code block may be low (S3010-S3140).

Referring to FIG. 3B, another exemplary method for determining the urgency and risk levels for an update procedure are illustrated. Accordingly, the target code block's frequency of use is measured. If the frequency of use is greater than a certain threshold (S3210), then it is determined whether the target block is known to have a bug (S3220). If yes, the update process is determined to be urgent (S3230), otherwise, the update process is determined to be highly risky (S3240).

On the other hand, if the frequency of use for the target block is less than a certain threshold, then it is determined whether a bug exist in the target block (S3250). If yes, then updating the target block will have a low risk associated with it (S3260), otherwise, if no bug exists in the target block, updating the target block may be deemed unnecessary (S3270).

Referring back to FIG. 2, if it is determined that a target code block is associated with a high urgency level and a low risk level (S2070), then system software 114 allows update code 118 to be executed to modify the target code block (S2090); if it is determined that a target code block is associated with a high urgency level and a high risk level (S2080) or a low urgency level and low risk (S2100), then system software 114 may not allow update code 118 to be executed to modify the target code block, and instead may provide one or more options to an independent decision maker, such as a user or the administrator on whether or not to modify the target code block (S2110); finally if a low urgency and a high risk level is associated with the target code block (S2120), system software 114 may delay or circumvent the update process for the target code block (S2130).

Accordingly, the urgency and risk assessments performed by system software 114 can either result in the automatic advancement or circumvention of the update process, or alternatively may provide a decision maker with insights as to the risk or urgency level associated with the proposed upgrade. In this manner, a decision maker can make an informed decision about whether to proceed or avoid a proposed update for software application 116.

In different embodiments, the invention can be implemented either entirely in the form of hardware or entirely in the form of software, or a combination of both hardware and software elements. For example, computing systems 110 and system software 114 or operating system 112 may comprise a controlled computing system environment that can be presented largely in terms of hardware components and software code executed to perform processes that achieve the results contemplated by the system of the present invention.

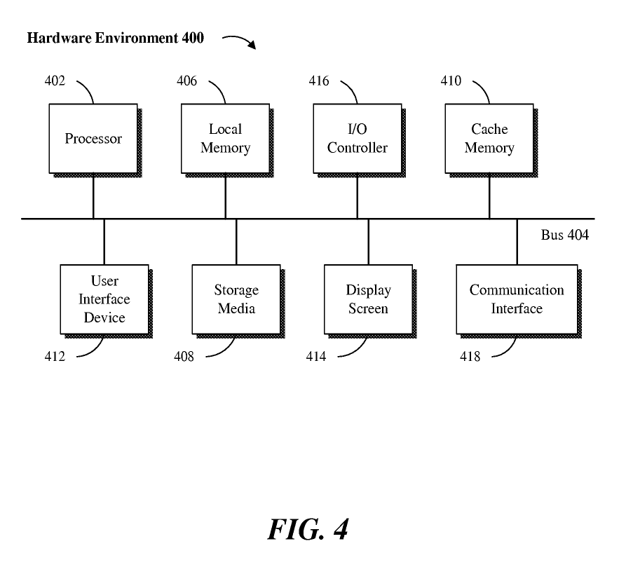

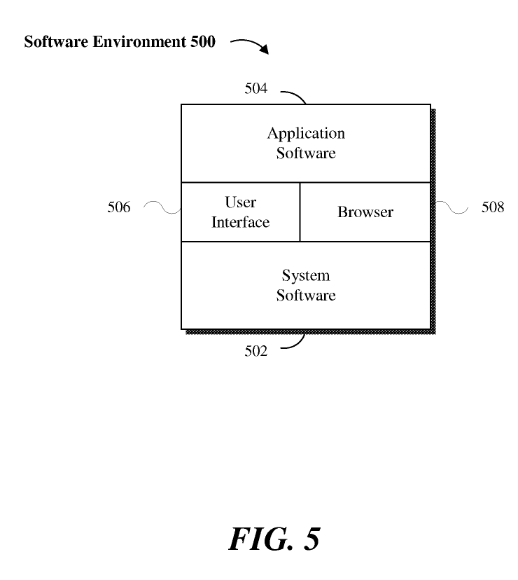

Referring to FIGS. 4 and 5, a computing system environment in accordance with an exemplary embodiment is composed of a hardware environment 400 and a software environment 500. The hardware environment 400 comprises the machinery and equipment that provide an execution environment for the software; and the software provides the execution instructions for the hardware as provided below.

As provided here, the software elements that are executed on the illustrated hardware elements are described in terms of specific logical/functional relationships. It should be noted, however, that the respective methods implemented in software may be also implemented in hardware by way of configured and programmed processors, ASICs (application specific integrated circuits), FPGAs (Field Programmable Gate Arrays) and DSPs (digital signal processors), for example.

Software environment 500 is divided into two major classes comprising system software 502 and application software 504. System software 502 comprises control programs, such as the operating system (OS) and information management systems that instruct the hardware how to function and process information.

In one embodiment, system software 114 may be implemented as system software 502 or application software 504 executed on one or more hardware environments to facilitate a selective and intelligence software update scheme as provided herein. Application software 504 may comprise but is not limited to program code, data structures, firmware, resident software, microcode or any other form of information or routine that may be read, analyzed or executed by a microcontroller.

In an alternative embodiment, the invention may be implemented as computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate or transport the program for use by or in connection with the instruction execution system, apparatus or device.

The computer-readable medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk read only memory (CD-ROM), compact disk read/write (CD-R/W) and digital videodisk (DVD).

Referring to FIG. 4, an embodiment of the system software 114 may be implemented as computer software in the form of computer readable code executed on a data processing system such as hardware environment 400 that comprises a processor 402 coupled to one or more computer readable media or memory elements by way of a system bus 404. The computer readable media or the memory elements, for example, can comprise local memory 406, storage media 408, and cache memory 410. Processor 402 loads executable code from storage media 408 to local memory 406. Cache memory 410 provides temporary storage to reduce the number of times code is loaded from storage media 408 for execution.

A user interface device 412 (e.g., keyboard, pointing device, etc.) and a display screen 414 can be coupled to the computing system either directly or through an intervening I/O controller 416, for example. A communication interface unit 418, such as a network adapter, may be also coupled to the computing system to enable the data processing system to communicate with other data processing systems or remote printers or storage devices through intervening private or public networks. Wired or wireless modems and Ethernet cards are a few of the exemplary types of network adapters.

In one or more embodiments, hardware environment 400 may not include all the above components, or may comprise other components for additional functionality or utility. For example, hardware environment 400 may be a laptop computer or other portable computing device embodied in an embedded system such as a set-top box, a personal data assistant (PDA), a mobile communication unit (e.g., a wireless phone), or other similar hardware platforms that have information processing and/or data storage and communication capabilities.

In certain embodiments of the system, communication interface 418 communicates with other systems by sending and receiving electrical, electromagnetic or optical signals that carry digital data streams representing various types of information including program code. The communication may be established by way of a remote network (e.g., the Internet), or alternatively by way of transmission over a carrier wave.

Referring to FIG. 5, system software 114 may comprise one or more computer programs that are executed on top of operating system 112 after being loaded from storage media 408 into local memory 406. In a client-server architecture, application software 504 may comprise client software and server software. For example, in one embodiment of the invention, client software is executed on computing systems 110 or 120 and server software is executed on a server system (not shown).

Software environment 500 may also comprise browser software 508 for accessing data available over local or remote computing networks. Further, software environment 500 may comprise a user interface 506 (e.g., a Graphical User Interface (GUI)) for receiving user commands and data. Please note that the hardware and software architectures and environments described above are for purposes of example, and one or more embodiments of the invention may be implemented over any type of system architecture or processing environment.

It should also be understood that the logic code, programs, modules, processes, methods and the order in which the respective steps of each method are performed are purely exemplary. Depending on implementation, the steps may be performed in any order or in parallel, unless indicated otherwise in the present disclosure. Further, the logic code is not related, or limited to any particular programming language, and may comprise of one or more modules that execute on one or more processors in a distributed, non-distributed or multiprocessing environment.

Therefore, it should be understood that the invention can be practiced with modification and alteration within the spirit and scope of the appended claims. The description is not intended to be exhaustive or to limit the invention to the precise form disclosed. These and various other adaptations and combinations of the embodiments disclosed are within the scope of the invention and are further defined by the claims and their full scope of equivalents.

What is claimed is:

1. A method for modifying executable logic code stored on a computing system, the method comprising:
assessing a risk level associated with modifying a first code block;
assessing an urgency level associated with modifying the first code block; and
based on the steps of assessing the first code block, evaluating whether the first code block should be modified.

2. The method of claim 1, wherein the urgency level and risk level are assessed based on execution history of the first code block and modification data associated with the first code block.

3. The method of claim 2, wherein data associated with execution history of the first code block comprises at least one of:
frequency of execution of the first code block, number of times the first code block is executed, number of times execution of the first code block has resulted in an error, and whether execution of the first code block supports execution of a second code block.

4. The method of claim 2, wherein the modification data comprises status information identifying whether the first code block is being modified for the purpose of at least one of:
fixing a problem encountered in executing the first code block, fixing a problem encountered in executing a second code block dependent on the first code block, and modified for improving functionality of the first code block.

5. The method of claim 1, wherein the urgency level is assessed as high, when the frequency of execution of the first code block is greater than a first threshold and the first code block has been determined to be faulty.

6. The method of claim 1, wherein the urgency level is assessed as low, when the frequency of execution of the first code block is less than a first threshold and the first code block has been determined not to be faulty.

7. The method of claim 1, wherein the risk level is assessed as high, when the frequency of execution of the first code block is greater than a first threshold and the first code block has not been determined to be faulty.

8. The method of claim 1, wherein the risk level is assessed as low, when the frequency of execution of the first code block is less than a first threshold and the first code block has been determined not to be faulty.

9. The method of claim 1, further comprising automatically modifying the first code block in response to assessing a high urgency level and a low risk level associated with modifying the first code block.

10. The method of claim 1, further comprising circumventing modification of the first code block, in response to assessing a low urgency level and a high risk level associated with modifying the first code block.

11. The method of claim 1, further comprising providing at least one option to an independent decision maker in response to assessing a high risk level and a high urgency level associated with modifying the first code block.

12. The method of claim 1, further comprising providing at least one option to an independent decision maker in response to assessing a low risk level and a low urgency level associated with modifying the first code block.

13. A system for modifying executable logic code stored on a computing system, wherein execution history of one or more code blocks in the logic code is available, the system comprising:
a logic unit for assessing a risk level associated with modifying a first code block;
a logic unit for assessing an urgency level associated with modifying the first code block; and
a logic unit for evaluating whether the first code block should be modified, based on the assessing.

14. The system of claim 13, wherein the urgency level and risk level are assessed based on execution history of the first code block and modification data associated with the first code block.

15. The system of claim 14, wherein data associated with execution history of the first code block comprises at least one of frequency of execution of the first code block, number of times the first code block is executed, number of times execution of the first code block has resulted in an error, and whether execution of the first code block supports execution of a second code block.

16. The system of claim 14, wherein the modification data comprises status information identifying whether the first code block is being modified for the purpose of at least one of fixing a problem encountered in executing the first code block, fixing a problem encountered in executing a second code block dependent on the first code block, and modified for improving functionality of the first code block.

17. A computer program product comprising a computer useable medium having a computer readable program, wherein the computer readable program when executed on a computer causes the computer to:
assess a risk level associated with modifying a first code block;
assess an urgency level associated with modifying the first code block; and
based on the assessments, evaluate whether the first code block should be modified.

18. The computer program product of claim 17 wherein the urgency level and risk level are assessed based on execution history of the first code block and modification data associated with the first code block.

19. The computer program product of claim 18 wherein data associated with execution history of the first code block comprises at least one of; frequency of execution of the first code block, number of times the first code block is executed, number of times execution of the first code block has resulted in an error, and whether execution of the first code block supports execution of a second code block.

20. The computer program product of claim 18 wherein the modification data comprises status information identifying whether the first code block is being modified for the purpose of at least one of; fixing a problem encountered in executing the first code block, fixing a problem encountered in executing a second code block dependent on the first code block, and modified for improving functionality of the first code block.
